(19) United States
(12) Patent Application Publication
(10) Pub. No.: US 2005/0144556 A1
(43) Pub. Date: Jun. 30, 2005

(54) XML schema token extension for XML document compression

(76) Inventors: Peter H. Petersen, Trenton, NJ (US); David D'Orto, Cherry Hill, NJ (US); Gregory Pavlik, Shamong, NJ (US); Neil Kenig, Mount Laurel, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/750,136

(22) Filed: Dec. 31, 2003

(51) Int. Cl. G06F 17/24

(52) U.S. Cl. 715/513

(57) ABSTRACT

A method for markup language document compression comprises defining a schema that specifies the structure of the markup-language conforming document and defining in the schema the types of elements and attributes that comprise the conforming document. The method further comprises assigning names in the schema for each of the elements and attributes of the document, defining relationships between the elements and between the attributes and the elements. The method further comprises assigning a token in the schema representing each element name and each attribute name of the document, and replacing each element name and each attribute name in the document with the assigned token.

### BACKGROUND

The advent of the World Wide Web, the development of markup languages, and the proliferation of user-friendly web-browsers have greatly enhanced the accessibility of data resources located on the Internet. The eXtensible Markup Language (XML) is a standard for creating markup languages, which allow the description of different types of data in addition to text data and simplify sharing of structured information. XML and other data description languages, for example ASN-1 [Abstract Syntax Notation, Version 1 (see web site http://www.asn1.org)], allow software developers to specify fundamental language syntax by defining a document type definition (DTD) that specifies constraints on the document structure. Alternatively, an XML schema may be defined, which describes the elements in an XML document. An XML schema allows multiple XML elements to share a common name. Resolution of an XML name is facilitated by a namespace.

### SUMMARY

In a first embodiment, a method for markup language document compression is provided. The method comprises defining a schema that specifies the structure of the markup-language conforming document and defining in the schema the types of elements and attributes that comprise the conforming document. The method further comprises assigning names in the schema for each of the elements and attributes of the document, defining relationships between the elements and between the attributes and the elements. The method further comprises assigning a token in the schema representing each element name and each attribute name of the document, and replacing each element name and each attribute name in the document with the assigned token.

In another embodiment, a system for markup language document compression is provided. The system comprises means for defining a schema that specifies the structure of a markup-language conforming document. The system further comprises means for defining in the schema the types of elements and attributes that comprise the conforming document and means for assigning names in the schema for each of the element and attribute names of the document. The system further comprises means for assigning a token in the schema representing each element name and each attribute name of the document, and means for replacing each element name and each attribute name in the document with the assigned token.

In yet another embodiment, a processing system is provided. The processing system comprises a markup-language conforming document having elements and attributes, such that each element name and each attribute name is represented in the document by a token, thereby compressing the document. The processing system further comprises a schema that specifies the structure of the document, the schema defining the token representing each element name and each attribute name. The processing system further comprises a software application operable to access the schema, and a processing element communicatively coupled with the software application, the processing element operable to retrieve and process the document in conjunction with the software application.

In yet another embodiment, computer-executable software code stored to a computer-readable medium is provided. The computer-executable software code comprises code for using a schema-defined markup language conforming document, wherein element names and attribute names of the document are replaced with tokens assigned and recorded in the schema.

### BRIEF DESCRIPTION OF THE DRAWINGS

FIG. 1A is a text display illustrating a traditional XML document;

FIG. 1B is a text display illustrating name/value attribute structure in a traditional XML element start tag;

FIG. 2 is a text display illustrating a traditional XML schema describing the structure of an XML document; and

FIGS. 3A-3B are flow diagrams in some embodiments, depicting a sequence of operations for markup language document compression; and

FIG. 3C is a schematic block diagram of an embodiment, depicting a processing system in which markup-language document compression may be advantageously implemented.

### DETAILED DESCRIPTION

The eXtensible Markup Language (XML) is a standard for creating markup languages. Languages based on XML can describe different types of data in addition to text data and can simplify sharing of structured information on the Internet. Documents written in an XML-based language may be processed by a program without knowledge of the language itself. Prior to the development of generalized data description languages such as XML and ASN.1, it was necessary to define a file format and a corresponding special purpose parser or other application to interpret the language. XML and other data description languages allow software developers to specify fundamental language syntax by defining a document type definition (DTD) that specifies constraints on the document structure. A typical DTD employed for interpretation of an XML document specifies allowable XML elements, attributes, and allowable attribute values. Alternatively, an XML schema may be defined.

An XML file is a text file, which must conform to various XML syntax rules. Particularly, an XML document must include a declaration that declares an identifier, which specifies the document as an XML-compliant file. A declaration can be considered as a definition. All identifiers must be declared. In XML, several things are said to be declared, e.g., namespaces, data types, and version. For example, the XML declaration may identify an XML version and may specify a character encoding format. XML encoding generally defaults to 8-bit Unicode Transformation Format (UTF-8), using the following declaration:
<?xml version=“1.0” encoding=“UTF-8”?>.

In XML terms, this is technically a so-called “processing instruction,” that in effect says “This is an XML document that conforms to XML specification version 1.0 and is encoded in a characterset called UTF-8.”

An XML-compliant document comprises a single root element, and elements containing data entries must be delineated with both a start tag, e.g., “<element_a>”, and an end tag, e.g., “</element_a>”. Additionally, attribute values are delineated with quotations, and nested (but not overlapping) tags are permissible.

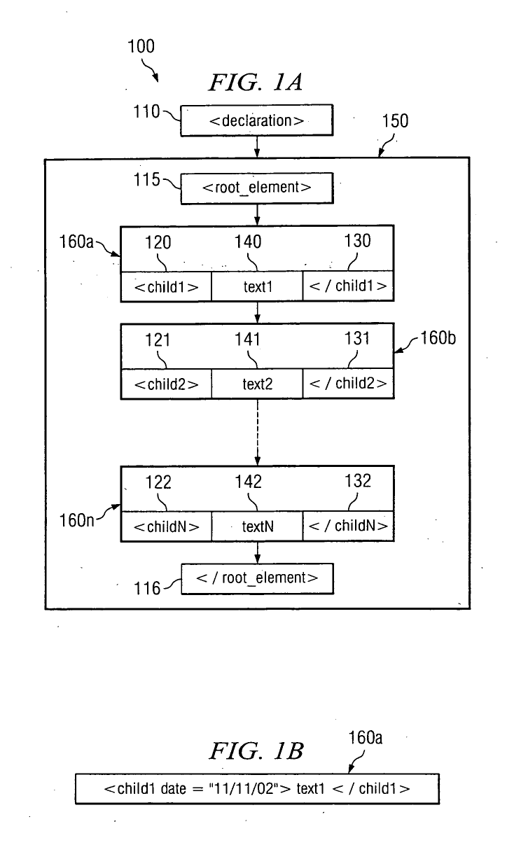

FIG. 1A is a text display illustrating a traditional XML document. XML document 100 comprises declaration 110, which defines the XML version and character encoding. XML document 100 comprises single root element 150 delineated with root element start tag 115 and root element end tag 116. Any elements between the root element start tag 115 and root element end tag 116 are referred to as child elements, for example child elements 160a-160n. In the illustrative example of FIG. 1A, root element 150 includes n child elements 160a-160n delineated with respective start tags 120-122 and end tags 130-132. Child elements 160a-160n respectively include element content 140-142 located between respective start tags 120-122 and end tags 130-132.

XML elements may comprise attributes that provide additional information about XML document 100 root element 150 and child elements 160a-160n. Attributes are defined by name/value pairs, where the value is placed between opening and closing quotations and is located in an element start tag. FIG. 1B is a text display illustrating name/value pair attribute structure in a traditional XML element start tag. For example, child element 160a may include an attribute defining a date, as depicted in FIG. 1B.

As outlined, XML documents can take any form, as long as it conforms with the XML specification, which requires two fundamental levels of conformance:
1. Well-formedness.
2. Conformance to a document type.

The first level requires that XML must be marked up in a specific way; for example:

<?xml version=“1.0”?>
<my_document>
<my_child>Some Text</my_child>
</my_document>

is well-formed, but does not declare conformance to a particular document type. However:

<?xml version=“1.0”?>
<my_document>
<my_child>Some Text</some_other_element>
</my_document>

is not well-formed, because the <my_child> element tag is incorrectly followed by a closing </some_other_element> element tag.

As described above, XML documents can declare conformance with a particular document type by using either a DTD or an XML schema. The DTD grammar/syntax is not extensible. By contrast, since an XML schema is an XML document in and of itself, it can inherently be extended to incorporate tokenization, as described below in more detail. Namespaces, while important, are orthogonal relative to the disclosed embodiments; in other words, the disclosed embodiments function with or without the use of namespaces. In this context, XML schemas themselves use namespaces. An XML schema basically serves the following purposes:
1. To define a namespace for the document type.
2. Define the types of elements and attributes that comprise a conforming document.
3. Define the relationship between elements (i.e. which elements can be children of which elements).
4. Define the relationship between attributes and elements (i.e. which attributes can be specified of which elements).

For items 3 and 4 above, the schema defines which elements/attributes are “allowed” as well as which are “required,” and in which sequence they can or must appear. Some schemas are relatively relaxed and others are very rigid, depending on the application for which they are explicitly designed. However, when using XML schemas, only elements and attributes declared in the schema for the particular namespace are allowed within that namespace, whereas XML documents can use multiple namespaces provided that their schemas allow it. Accordingly, an XML schema defines the allowed/required elements, attributes and relationships for a particular namespace only.

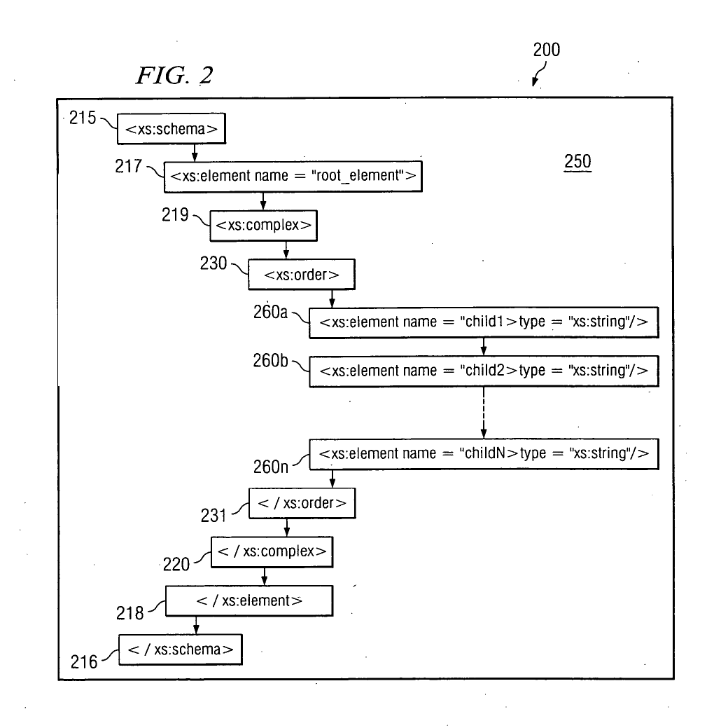

FIG. 2 is a text display illustrating a traditional XML schema describing the structure of XML document 100. An XML schema may define allowable elements and attributes, may define which elements are child elements and in which child element order, may define allowable data types for elements and attributes, and may define other structural characteristics of an XML document. XML schema 200 comprises schema element 250 delineated with start tag 215 and end tag 216. The root element in lines 217-218 is declared to be of complex type in lines 219-220, because the root element contains other elements, i.e., the root element contains child elements. In the event that any child elements 160a-160n contain nested elements, then the child element containing nested elements will as well have a type declared as complex. In the illustrative example, each of child elements 160a-160n contains only text elements (strings) and is declared accordingly in lines 260a-260n of schema 200. Other data, for example namespace definition and attributes, can typically be included in the schema declaration. Namespace definition in lines 230-231 may provide a source reference that defines the various data types, e.g., order, complex, string, etc., and facilitates interpretation of XML objects that may share a common name.

For clarity, the following single-namespace example XML schema for purchase order documents generated by the Hewlett-Packard Company (HP) illustrates as well the principles applicable for more complex cases:

```
<xsd:schema
    xmlns:xsd=“http://www.w3.org/2001/XMLSchema”
    targetNamespace=“http://www.hp.com/PO”
    elementFormDefault=“qualified”
    attributeFormDefault=“unqualified”>
<xsd:annotation>
  <xsd:documentation xml:lang=“en”>
    Purchase order schema for hp.com
    Copyright 2000 Hewlett-Packard. All rights reserved.
  </xsd:documentation>
</xsd:annotation>
<xsd:element name=“purchaseOrder” type=“PurchaseOrderType”/>
<xsd:element name=“comment” type=“xsd:string”/>
<xsd:complexType name=“PurchaseOrderType”>
  <xsd:sequence>
    <xsd:element name=“shipTo” type=“USAddress”/>
    <xsd:element name=“billTo” type=“USAddress”/>
    <xsd:element ref=“comment” minOccurs=“0”/>
    <xsd:element name=“items” type=“Items”/>
    </xsd:sequence>
    <xsd:attribute name=“orderDate” type=“xsd:date”/>
  </xsd:complexType>
  <xsd:complexType name=“USAddress”>
    <xsd:sequence>
      <xsd:element name=“name” type=“xsd:string”/>
      <xsd:element name=“street” type=“xsd:string”/>
      <xsd:element name=“city” type=“xsd:string”/>
      <xsd:element name=“state” type=“xsd:string”/>
      <xsd:element name=“zip” type=“xsd:decimal”/>
    </xsd:sequence>
    <xsd:attribute name=“country” type=“xsd:NMTOKEN”
        fixed=“US”/>
  </xsd:complexType>
  <xsd:complexType name=“Items”>
    <xsd:sequence>
      <xsd:element name=“item” minOccurs=“0” maxOccurs=
      “unbounded”>
        <xsd:complexType>
          <xsd:sequence>
            <xsd:element name=“productName” type=“xsd:string”/>
            <xsd:element name=“quantity”>
              <xsd:simpleType>
                <xsd:restriction base=“xsd:positiveInteger”>
                  <xsd:maxExclusive value=“100”/>
                </xsd:restriction>
              </xsd:simpleType>
            </xsd:element>
            <xsd:element name=“USPrice” type=“xsd:decimal”/>
            <xsd:element ref=“comment” minOccurs=“0”/>
            <xsd:element name=“shipDate” type=“xsd:date”
            minOccurs=
            “0”/>
          </xsd:sequence>
          <xsd:attribute name=“partNum” type=“SKU”
          use=“required”/>
        </xsd:complexType>
      </xsd:element>
    </xsd:sequence>
  </xsd:complexType>
  <!-- Stock Keeping Unit, a code for identifying products -->
  <xsd:simpleType name=“SKU”>
    <xsd:restriction base=“xsd:string”>
      <xsd:pattern value=“\d{3}-[A-Z]{2}”/>
    </xsd:restriction>
  </xsd:simpleType>
</xsd:schema>
```

An annotation element in an XML schema documents the schema with information that is above and beyond the actual schema declaration itself needed by an XML processor. Thus, annotation elements have value as comments for human readers only. The documentation element is an annotation child element that lets the author of the schema document what different parts mean and do, totally free from and completely ignored by the consumer of the XML document(s) that adhere/conform to the schema. In the above XML schema, xml:lang=“en” is an attribute, named “lang”, that belongs to the special “xml” namespace and simply declares that the language of this documentation element is English. (This is another example of an attribute from one namespace being used on an element from another).

The above XML schema defines purchase order documents as shown below for the declared target namespace (in this case, http://www.hp.com/PO).

```
<?xml version=“1.0”?>
<po:purchaseOrder
  xmlns:po=“http://www.hp.com/PO”
  orderDate=“2003-04-01”>
  <po:shipTo country=“US”>
      <po:name>John Doe</po:name>
      <po:street>123 Main St</po:street>
    <!-- and so on -->
  </po:shipTo>
</po:purchaseOrder>
```

A name, e.g., an element name or attribute name, comprises a token that begins with an alphabetic symbol or one of a set of acceptable punctuation characters. A token is a derived XML data type and is limited to the set of XML data types length, minLength, maxLength, pattern, enumeration, and whiteSpace. A name is an XML token and is interpreted in accordance with an XML namespace.

A namespace is used to identify one or more elements. An element named “Address” can mean different things to different people. Thus, to specify, e.g., in an XML schema, that an Address element must be a part of a document can be ambiguous, for example, a US postal “address” or a network “address.” To remove the ambiguity, XML supports the notion of namespaces, which provide a unique context for the declaration of the elements in question. The above XML purchase order document, for example, declares the namespace “http://www.hp.com/PO” and assigns the prefix of “po”. It then prefixes the elements of the document (purchaseOrder, shipTo, name, street and so on) with “po:” indicating that, in this instance, these elements belong to (and should be interpreted by the reader, human or otherwise, in this context) a particular namespace, specifically “http://www.hp.com/PO”.

An XML schema is a very flexible mechanism, which both describes the XML document and most often also prescribes it. Expressed differently, an XML schema describes what elements and attributes make up a particular type of document, and may specify a more or less rigid document structure as well. As an example, the complex type “PurchaseOrderType” defined in the above example schema, which contains a sequence of “shipTo”, “billTo”, “comment” and “items” elements, prescribes both which elements are allowed/required and the sequence in which the elements must occur. Additionally, it includes the attribute declaration of “orderDate” (with a type of “date”). In other words, the XML schema defines the types (purchase order, ship to address, bill to address), the relationship(s) (a purchase order must have a ship to address) and the sequence (the bill to address must follow the ship to address). Additionally, XML schema can be used to define choices (e.g. a purchase order could have a choice between a “rush order” and “normal order”) and optionality/multiplicity of elements (using the “minOccurs” and “maxOccurs” declarations. A minOccurs of 0 makes an element optional, a minOccurs of 1 or more makes an element required, and maxOccurs limits the number of elements). In the purchase order example, the comment element is optional (minOccurs is 0).

In the above address element example, an application may need to receive billing data pertaining to leasing of network nodes and to know about the physical location of network equipment (the US postal address) as well as the network node address (some arbitrary network specific node address used by the network infrastructure). If the XML schema for this data was one schema created by a single person, the ambiguity could be handled by declaring “PostalAddress” and “NodeAddress” elements, their naming making their meaning clear. However, it is often the case that XML is used to describe data from several systems, created by several people, making it quite likely that both XML schemas could have an element named Address. To remove the ambiguity, the document declares multiple namespaces and uses them to contextualize the elements, for example:

```
<?xml version=“1.0”?>
<billing:bill
  xmlns:billing=“http://www.hp.com/billing”
  xmlns:network=“http://www.networking.org/nodes”>
  <billing:Address>
    <billing:Street>123 Main St.</billing:Street>
    <billing:City>Springfield</billing:City>
    <!-- etc. -->
  <billing:Address>
  <network:Address>
    <network:Node>1234-56-789-ABC</network:Address>
    <network:SerialNumber>QWERTY-9876</network:Address>
  </network:Address>
  <billing:Amount>$123.45</billing:Amount>
</billing:bill>
```

When using namespaces (whether in XML schema or XML documents), they are first declared and then used (i.e. referred to). In the above example, two namespaces are declared, namely, the billing namespace and the network namespace. Both would have an XML schema describing the document structure and both would have an Address element. Without the multiple namespace declarations, the reader would not know what each Address element means, whereas by declaring and using both namespaces, the context of the Address elements is clear. For example, the declaration of a namespace takes the form:
<SomeElement xmlns:prefix=“http://whatnot/this/that”>

Here, xmlns, which is part of the XML grammar, means “declare a new XML namespace”. Namespaces are URIs, which resemble Internet URLs. Although there is nothing located at the specified URI, it is guaranteed to be unique, and therefore it meets the requirements for a namespace. Namespaces are declared with a prefix, which can be any word. The prefix is chosen by the person or application that produces the XML document, and is purely a “synonym” for the actual namespace itself. The reasoning is that it is easier to read, e.g., “po:purchaseOrder” than, e.g., “http://www.hp.com/PO:purchaseOrder”. While the prefix can be an arbitrary word, it is common practice to select a meaningful alphanumeric symbol (e.g. the “po” for “purchase order”). In this context, the term “xsd” is a prefix chosen as the default prefix, meaning XML Schema Definition. The schema would be equally valid using an arbitrary prefix, for example, “zbcd”, which would, however, typically make little sense to a human reader.

elementFormDefault=“qualified” and attributeFormDefault=“unqualified” are XML schema declarations that prescribe the default interpretation of “qualified” vs. “unqualified” element- and attribute names. A qualified name is of the form “prefix:name” and an unqualified name is simply “name”. By declaring elementFormDefault=“qualified,” the XML schema specifies that the default form of specifying element names must be qualified. Conversely, by declaring attributeFormDefault=“unqualified,” the XML schema specifies that the default form of specifying attributes is unqualified. While cryptic, this has to do with how an XML processor is to interpret unqualified names. As a rule of thumb, any unqualified name is to be interpreted as belonging to its parent's namespace. With the declarations at hand, the fragment
<po:purchaseOrder orderDate=“2003-04-01”>
   is really
<po:purchaseOrder po:orderDate=“2003-04-01”>

In other words, the orderDate, although unqualified, really belongs to the same namespace as the purchaseOrder element. Had the declaration instead been
attributeFormDefault=“qualified”,
   the orderDate attribute would be interpreted as not belonging to a namespace.

When to use a form is application-specific and depends on intent. The form in the purchase order XML schema example is common, because it requires only that the element names to be qualified, whereas no attributes need be qualified. Further, because attributeFormDefault is “unqualified” does not preclude the use of qualified attribute names. There are many existing examples of elements in one namespace that accept/require attributes from another namespace, for example in:
<po:purchaseOrder orderDate=“2003-04-01” hp:priority=“HIGH”>, the orderDate attribute belongs to the namespace declared for the po prefix, while the priority attribute belongs another namespace, declared for the hp prefix (both omitted for clarity).

An XML schema is itself an XML document. In XML, elements may or may not have child elements (per their schema). For example, in the XML text below:

<SomeElement>
<AnotherElement>Some Text</AnotherElement>
</SomeElement>

The elements whose names begin with /(forward slash) are “end elements”. The above document should be “read” as:
begin SomeElement
begin AnotherElement
Some Text
end AnotherElement
end SomeElement

If the SomeElement element did not have the child element AnotherElement, the text could be written as:

<SomeElement>
</SomeElement>

or in shorthand, simply:
<SomeElement/>

Thus, any element, whether in a schema or in another XML document, that has no child elements, can be coded as above. With attributes, for example:
<SomeElement someAttribute=“Some Value”/>

The above example XML schema previously defined the example XML purchase order document as shown below:

```
<?xml version=“1.0”?>
<po:purchaseOrder
  xmlns:po=“http://www.hp.com/PO”
  orderDate=“2003-04-01”>
  <po:shipTo country=“US”>
      <po:name>John Doe</po:name>
      <po:street>123 Main St</po:street>
    <!-- and so on -->
  </po:shipTo>
</po:purchaseOrder>
```

In the above example XML purchase order document, the names of the elements and attributes consume a substantial amount of space. It is possible, of course, to define a schema with much shorter names, but then the “self describing” advantage of XML, containing both the data (e.g., the date, sku, and quantity) and the metadata (e.g., the name/type of the message and the names of the data elements it carries) is sacrificed. In accordance with the disclosed embodiments, “tokens” are defined for all the elements and attributes. The example below illustrates declaration of the “hpt” namespace for HP tokens as well as the addition of the hpt:token=. . . on all declared types. In this example, for simplicity numbers are used as tokens for elements, and letters are used as tokens for attributes. In general, however, the disclosed embodiments allow the use of any text symbol(s) for any tokens.

An XML schema type of NMTOKEN is a string with certain properties, which can contain only letters, digits and certain special characters, for example “_” and “-”. NMTOKEN means Name TOKEN, and attributes of type NMTOKEN are often names of things, for example a person's name, a state name, or country name. In this context an NMTOKEN has no particular meaning with respect to the disclosed embodiments. It is simply a special data type, recognized by XML processors along the same lines of numbers and regular strings. The disclosed embodiments provide for compression (by tokenization) of XML documents.

In general XML processing takes place when the XML is created, usually from some kind of business data (such as a purchase order), and when parsed so that the business data can be “extracted” and used by the application (such as the purchase order system).

An XML document is a text document that contains (hopefully) correct mark up, which adheres to a certain schema. It is the responsibility of the creator (usually an application) of the XML to produce correct and conformant XML, and there are numerous ways to do this. Roughly speaking a user can either construct the XML document directly, using nothing but text strings (this makes sense because it directly results in the desired end-result—the XML document), or construct a representation of the document in a computer language object model, usually (but not necessarily) the standard document object model or DOM. In either case the application can end up with incorrect XML (i.e. a document that does not conform to the schema), either because of a programming error or corrupt data. Since the consumer of the XML document usually parses the document, it can be assumed relatively safely that it will validate it, so in real life few creator applications will actually validate the XML they generate, although that is possible. For the sake of describing the tokenization process, it can take place after the fact, i.e., after the creator application has constructed the XML document and is ready to e.g. send it to a receiver application. With this approach, it does not matter how the XML document is constructed, but probably not the most efficient way.

A consumer application needs to “extract” the business data out of the XML document—a process known as parsing. Few applications perform their own parsing, but usually rely on a standard XML parser to be available—such as those found in Java, Net and C++. The result of the parsing depends on the application. For example, many elect to have a DOM returned although other mechanisms are available. For efficiency purposes, de-tokenization of the XML document typically takes place during parsing, because the parser already has to read the XML schema (in which the tokens are defined as previously discussed. However, for the sake of describing the process clearly, de-tokenization may take place before the consumer application receives the document.

In a simple operational flow, the sequence of events would be as follows:
1. Creator application constructs XML document, for example a purchase order.
2. XML document is tokenized, using the appropriate schema.
3. XML document is sent to receiving system.
4. XML document is de-tokenized, using the appropriate schema.
5. XML document is presented to consumer application and parsed.

Alternatively, the document could e.g. be stored in a database or file for later use as opposed to being sent to another application.

Also note that the schemas mentioned in events 2 and 4 are actually the same schema, typically made available via the internet, an extranet, or a simple corporate network. Importantly, both the creator and consumer of the XML document have access to the schema, without having it sent or stored with the XML document.

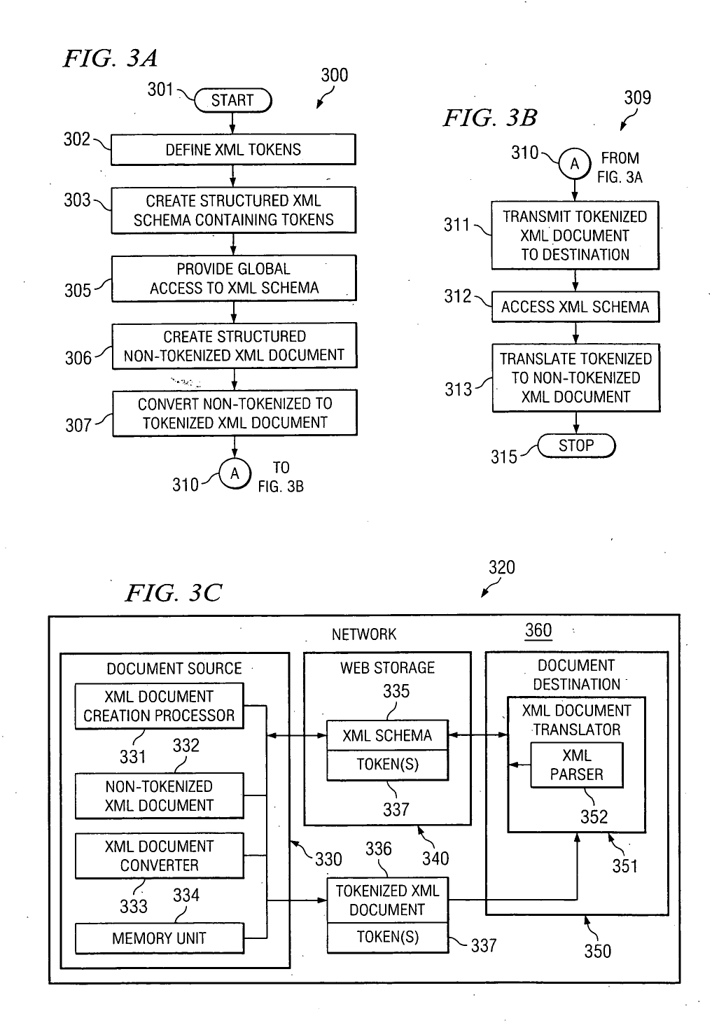

FIGS. 3A-3B are flow diagrams in some embodiments, depicting a sequence of operations 300 for markup language document compression. FIG. 3C is a schematic block diagram of an embodiment, depicting processing system 320, in which markup-language document compression may be advantageously implemented. Referring to FIG. 3A, in operation 302 at document source 330, XML tokens 337 are defined in terms of the specific elements and attributes that they represent in compressed XML document 336. In operation 303, XML schema 335 structured to embed tokens 337 with each of their corresponding elements and attributes is created using creator application, e.g., XML document creation processor 331. It will be noted that XML schema 335 is itself not tokenized, but merely contains embedded tokens. Additionally, XML schema 335 is itself an XML document that describes the structure of XML documents that adhere to that schema.

As illustrated in the XML schema below, each element and attribute is assigned a short token (i.e., alias, synonym, symbol) such that the element or attribute can be represented using significantly fewer characters, thus making storage (in file or database) and/or transmission over a network much more efficient.

```
<xsd:schema
      xmlns:xsd=“http://www.w3.org/2001/XMLSchema”
      xmlns:hpt=“http://www.hp.com/XMLSchema/tokens”
      targetNamespace=“http://www.hp.com/PO”
      elementFormDefault=“qualified”
      attributeFormDefault=“unqualified”>
  <xsd:annotation>
    <xsd:documentation xml:lang=“en”>
      Purchase order schema for hp.com
      Copyright 2000 Hewlett-Packard. All rights reserved.
    </xsd:documentation>
  </xsd:annotation>
    <xsd:element name=“purchaseOrder” type=
    “PurchaseOrderType”/>
    <xsd:element name=“comment” type=“xsd:string” hpt:token=“0”/>
    <xsd:complexType name=“PurchaseOrderType” hpt:token=“1”>
      <xsd:sequence>
        <xsd:element name=“shipTo” type=“USAddress”/>
        <xsd:element name=“billTo” type=“USAddress”/>
        <xsd:element ref=“comment” minOccurs=“0”/>
        <xsd:element name=“items” type=“Items”/>
      </xsd:sequence>
      <xsd:attribute name=“orderDate” type=“xsd:date” hpt:token=“A”/>
    </xsd:complexType>
    <xsd:complexType name=“USAddress” hpt:token=“2”>
      <xsd:sequence>
        <xsd:element name=“name” type=“xsd:string” hpt:token=“3”/>
        <xsd:element name=“street” type=“xsd:string” hpt:token=“4”/>
        <xsd:element name=“city” type=“xsd:string” hpt:token=“5”/>
        <xsd:element name=“state” type=“xsd:string” hpt:token=“6”/>
        <xsd:element name=“zip” type=“xsd:decimal” hpt:token=“7”/>
      </xsd:sequence>
      <xsd:attribute name=“country” type=“xsd:NMTOKEN”
          fixed=“US” hpt:token=“B”/>
    </xsd:complexType>
    <xsd:complexType name=“Items” hpt:token=“8”>
      <xsd:sequence>
        <xsd:element name=“item” minOccurs=“0” maxOccurs=
        “unbounded”
  hpt:token=“9”>
      <xsd:complexType>
        <xsd:sequence>
          <xsd:element name=“productName” type=
          “xsd:string” hpt:token=“10”/>
            <xsd:element name=“quantity” hpt:token=“11”>
              <xsd:simpleType>
                <xsd:restriction base=“xsd:positiveInteger”>
                  <xsd:maxExclusive value=“100”/>
                </xsd:restriction>
              </xsd:simpleType>
            </xsd:element>
            <xsd:element name=“USPrice” type=“xsd:decimal”
            hpt:token=“12”/>
            <xsd:element ref=“comment” minOccurs=“0”/>
            <xsd:element name=“shipDate” type=“xsd:date”
            minOccurs=“0”
hpt:token=“13”/>
        </xsd:sequence>
        <xsd:attribute name=“partNum” type=“SKU” use=“required”/>
      </xsd:complexType>
      </xsd:element>
    </xsd:sequence>
  </xsd:complexType>
  <!-- Stock Keeping Unit, a code for identifying products -->
  <xsd:simpleType name=“SKU” hpt:token=“14”>
    <xsd:restriction base=“xsd:string”>
      <xsd:pattern value=“\d{3}-[A-Z]{2}”/>
    </xsd:restriction>
  </xsd:simpleType>
</xsd:schema>
```

Referring again to FIG. 3A, in operation 305, global access to XML schema 335 is provided, for example by storing XML schema 335 on web storage facility 340 typically associated with a web server on network 360, where it is accessible globally through a URL. For a schema to be useful (especially in the context of, e.g., business-to-business communication), it should be made available globally; in other words, the schema in question does not accompany the XML documents it describes, but is rather made available by a defining entity (either a standards organization or a company) via the internet, as normal html pages are available at a particular URL. For example, HP could make a purchase order schema available at http://www.hp.com/schemas/po.xsd.

In operation 306, structured non-tokenized XML document 332, for example a purchase order, is created in XML document creation processor 331. The creation of non-tokenized XML document 332 references XML schema 335 to provide appropriate tokens 337, which enable validation of the document when processed. The schema contains tokens 337 associated with each element and attribute name. In order to generate XML document 332 automatically, document creation processor 331 needs to look up the respective element and attribute names embedded in XML schema 335.

The non-tokenized XML purchase order document from HP, will, for example, look like:

<po:purchaseOrder xmlns:po=http://www.hp.com/PO

| | |
|---|---|
| > | xmlns:xsi=http://www.w3.org/2001/XMLSchema-instance |
| > | xsi:schemaLocation=“http://www.hp.com/schemas/po.xsd”> |

<!-- etc... -->
</po:purchaseOrder>

In the above example, xmlns:po simply describes the namespace to which this document belongs. Likewise, xmlns:xsi defines the XML schema instance namespace, as defined by the W3C organization (all schemas must adhere to their specification and use their namespace). The last crucial declaration is the xsi:schemaLocation attribute which points to the actual schema (a text file, just like an html page) at the specified URL.

Non-tokenized XML document 332 can be generated manually or automatically using any of a number of available techniques for XML document generation. Manual generation is typically tedious, error prone, and time consuming, particularly in a high volume application, e.g., purchase order generation. Once the non-tokenized XML document exists, it is converted at the document source to a tokenized XML document using a simple process. In operation 307, non-tokenized XML document 332 is converted automatically to tokenized compressed XML document 336 by accessing XML schema 335 using XML document converter 333 and can, for example, be subsequently stored in memory unit 334. In order to generate tokenized XML document 336 automatically, the schema is needed. The document converter looks up, e.g., the “purchaseOrder” element and finds the token “a”.

Once a traditional XML document has been created, the tokenizer, e.g., XML document converter 333, parses it into the elements and attributes specified in the XML mark up. The location of schema 335 is identified, using the schemaLocation attribute, as previously mentioned The tokenizer reads and parses schema 335, which is itself an XML document, thereby being able to map the element and attribute names with their assigned token 337. This mapping relationship can be, for example, stored in a keyed data structure in memory, allowing an element or attribute name to be used as a lookup key and the corresponding token to be returned. Once the schema has been fully read, parsed, and processed, it is a simple matter of iterating all the way through the XML document elements and all their associated attributes, looking up each one of them in turn and replacing the real name with the corresponding token. The end result is tokenized XML document 336 with structure and business data identical with non-tokenized XML document 332, but with every element and attribute name replaced by a short token 337.

Alternatively, tokenized XML document 336 may be generated “from scratch” in tokenized format, bypassing non-tokenized XML document 332, but only if the processing system is intimately aware of the tokenization process. As mentioned above, there are several techniques available for generating XML documents, and typically document sources will use whatever means available. Consequently, in accordance with the embodiments, the tokenization step is typically performed either “behind the scenes” or after the fact, so that existing systems do not have to be modified.

Operation 307 concludes the creation of tokenized compressed XML document 336, after which additional operations can occur, starting at operation 310, including in some embodiments transmitting and/or translating of tokenized XML document 336.

A tokenized version of the purchase order would, for example, look like:

```
> <po:a xmlns:po=http://www.hp.com/PO
    > xmlns:xsi=http://www.w3.org/2001/XMLSchema-instance
    > xsi:schemaLocation=“http://www.hp.com/schemas/po.xsd”>
> <po:b 1=“12345” 2=“2003-09-20”>
    > <po:c>HP</po:c>
    > <po:d>1 Hewlett Avenue</po:d>
    > <po:e>Cupertino</po:e>
    > <po:f>CA</po:f>
    > <po:g>98765</po:g>
    > </po:b>
> <!-- etc... -->
> </po:a>
```

The document is accordingly compressed, but because the token information is in the schema, an application can retrieve and reconstruct the full information. While the embodiments disclosed herein do not preclude applications (or people) from using the tokenized XML document directly, the compressed/tokenized format is advantageous primarily when storing the documents (for example in a database) and when sending them from point a to point b (such as a purchase from company A to company B, e.g., via the internet). Since schemas are normally accessible via internet/extranet(s), the schema information never needs to be stored or transmitted with the documents themselves. Applications that use XML documents obtain schemas from a known location (or from a location defined in the documents themselves).

The element and attribute names in the original document consume about 75 characters, whereas in the compressed/tokenized document, the tokens consume only 9 characters, a significant space saving, particularly for such a short document. Scaling to larger documents with hundreds of elements and attributes and then to thousands of such documents being stored and/or transmitted over a network, tokenized documents will consume much less space and transmit much faster than corresponding non-tokenized documents, thus requiring smaller network bandwidth.

FIG. 3B depicts a sequence of operations 309 occurring subsequent to operation 310 in some embodiments. In operation 311, tokenized XML document 336 is transmitted across network 360 from document source 330 to a receiving system, for example document destination 350. If document source 330 sends a purchase order to document destination 350 that adheres to the po.xsd schema example described above, and that is tokenized for efficiency in, e.g., a database and bandwidth over the communication medium, the purchase order processing system or consumer application associated with document destination 350 reconstitutes original XML document 332, as described previously.

When tokenized XML document 336 is received by document destination 350, their purchase order processing system needs to reconstitute original XML document 332. This requires access to XML schema 335. Since the schema is needed anyway, because it is referenced by XML document 332 and used to validate that it is correct, this does not impose an extra requirement on the system. When parsing the XML document, the schema is also used to replace the tokens with the actual element- and attribute names. Accordingly, XML document translator 351 utilizing XML parser 352 reads tokenized XML document 336, recognizes the URL of XML schema 335, and in operation 312 accesses XML schema 335 stored on web storage facility 340 in network 360 and retrieves the element and attribute names represented by tokens 337 in tokenized XML document 336. In operation 313, XML document translator 351 proceeds to utilize parser 352, and tokens 337 retrieved from XML schema 335 to translate tokenized XML document 336 and thereby reconstruct non-tokenized XML document 332.

Accordingly, when parsing tokenized XML document 336, the destination system looks up the schema element with token “a” and finds “purchaseOrder”; looks up element with token “b” and finds “address” and so on. Since most systems that are XML-aware use an XML parser for this, XML parsers can very easily be made “token aware” and can process tokenized documents completely transparently to the applications that use them. Most “systems” or applications use an XML parser to parse an XML document into a data structure with which it is comfortable. For example, most Java applications use a standard Java parser to accomplish this. Other programming languages have other means available to them, e.g., as with Java, C++ has a number of available standard parsers.

The schema contains the information needed to do the translation from tokens to real element and attribute names, but is not itself a “processor.” Information obtained from the schema is used by the consumer application, e.g., XML document translator 351 or XML parser 352 having this processing capability built into it.

The de-tokenization process is analogous in nature to the tokenization process, except that when the schema is processed, the token is used as the key in the keyed data structure, allowing the original element or attribute name to be returned when the corresponding token is looked up.

The translation process could be done, for example, before parsing XML document 336. For efficiency, however, it would make sense to perform parsing and translation in a single step, since the parsing process involves reading the schema anyway. Normal parsing is substantially the same as translating, with the exception of the look up and replacement of element and attribute names. If translation occurs before parsing takes place, the schema would have to be read twice. In a typical real-world scenario, de-tokenization may be performed concurrently with other processing by the standard parser, although either implementation sequence conforms to the present embodiments.

Following recovery of non-tokenized XML document 332, starting at operation 315 additional operations may occur, including in some embodiments printing, display, or storage of reconstructed XML document 332.

1. A method for markup language document compression, comprising:
defining a schema that specifies the structure of a markup-language conforming document;
defining in said schema the types of elements and attributes that comprise said conforming document;
assigning names in said schema for each of said elements and attributes of said document;
defining relationships between said elements;
defining relationships between said attributes and said elements;
assigning a token in said schema representing each said element name and each said attribute name of said document; and
replacing in said document each said element name and each said attribute name with said assigned token.

2. The method of claim 1 further comprising declaring a namespace in said schema for said tokens.

3. The method of claim 1 wherein numbers and alphabetic characters are used for tokens.

4. The method of claim 3 wherein said numbers are used for said tokens representing said element names and said alphabetic characters are used for said tokens representing said attribute names.

5. The method of claim 1 wherein said assigning comprises parsing said schema.

6. The method of claim 1 further comprising storing said document in a computer-readable storage medium.

7. The method of claim 1 further comprising storing said schema in a computer-readable storage medium.

8. The method of claim 7 further comprising storing said document in a computer-readable storage medium separately from said schema.

9. The method of claim 7 further comprising transmitting said document separately from said schema.

10. The method of claim 9 further comprising:
receiving said separately transmitted document by an application; and
retrieving token information in said schema by accessing said separately stored schema.

11. The method of claim 10 further comprising accessing said stored schema by said application from a location selected from the group consisting of known locations and locations defined in said document.

12. The method of claim 11 further comprising replacing each token with an assigned element and/or attribute name.

13. The method of claim 12 comprising parsing said schema.

14. The method of claim 1 wherein said markup language comprises extensible Markup Language (XML).

15. A system for markup language document compression, comprising:
means for defining a schema that specifies the structure of a markup-language conforming document;
means for assigning names in said schema for each of said elements and attributes of said document;
means for assigning a token in said schema representing each said element name and each said attribute name of said document; and
means for replacing in said document each said element name and each said attribute name with said assigned token.

16. The system of claim 15 further comprising means for parsing said markup-language conforming document.

17. The system of claim 15 wherein numbers and alphabetic characters are used for tokens.

18. The system of claim 15 further comprising means for storing said document in a computer-readable storage medium.

19. The system of claim 18 further comprising means for storing said schema separately from said document in a computer-readable storage medium.

20. The system of claim 19 further comprising means for transmitting said document separately from said schema.

21. The system of claim 20 further comprising:
means for receiving said separately transmitted document by an application; and
means for replacing said tokens with said assigned element and/or attribute names.

22. The system of claim 15 wherein said markup language comprises extensible Markup Language (XML).

23. A processing system comprising:
a markup-language conforming document, said document having elements and attributes such that each element name and each attribute name is represented in said document by a token, thereby compressing said document;
a schema that specifies the structure of said document, said schema defining said token representing each said element name and each said attribute name;
a software application operable to access said schema; and
a processing element communicatively coupled with said software application, said processing element operable to retrieve said document and operable to process said document in conjunction with said software application.

24. The processing system of claim 23 further comprising a memory unit communicatively coupled with said software application and said processing element, said memory unit operable to provide said document to said software application and said processing element.

25. The processing system of claim 23 further comprising a storage facility operable to provide said schema to said software application.

26. The processing system of claim 23 further comprising a document destination facility incorporating a document translator.

27. The processing system of claim 26 wherein said document translator is operatively coupled with a document parser.

28. The processing system of claim 23 wherein said markup language comprises eXtensible Markup Language (XML).

29. Computer-executable software code stored to a computer-readable medium, said computer-executable software code comprising:
code for using a schema-defined markup language conforming document, wherein element names and attribute names of said document are replaced with tokens assigned and recorded in said schema.

30. The computer-executable software code of claim 29, further comprising code for storing said document to a computer-readable storage medium.

31. The computer-executable software code of claim 29, further comprising code for storing said schema to a computer-readable storage medium separately from said document.

32. The computer-executable software code of claim 31, further comprising code for transmitting said document separately from said schema.

33. The computer-executable software code of claim 32, further comprising:
code for receiving said separately transmitted document by an application; and
code for replacing said tokens with said assigned element and/or attribute names.

34. The computer-executable software code of claim 29 wherein said markup language comprises eXtensible Markup Language (XML).
